(19) United States
(12) Patent Application Publication
(10) Pub. No.: US 2013/0102331 A1
(43) Pub. Date: Apr. 25, 2013

(54) Apparatus, Method, Computer Program and User Interface

(71) Applicant: Nokia Corporation, Espoo (FI)

(72) Inventors: Erika Piia Pauliina Reponen, Tampere (FI); Jaakko Olli Taavetti Keranen, Tampere (FI)

(73) Assignee: Nokia Corporation, Espoo (FI)

(21) Appl. No.: 13/715,043

(22) Filed: Dec. 14, 2012

Related U.S. Application Data
(63) Continuation of application No. 12/759,779, filed on Apr. 14, 2010.

(51) Int. Cl. H04W 24/00

(52) U.S. Cl. CPC H04W 24/00
USPC 455/456.3

(57) ABSTRACT

A method, apparatus, computer program and user interface wherein the method includes displaying, on a display of an apparatus, a first plurality of content items, over a first period of time, in response to the apparatus being positioned in a first position; wherein during the first period of time a first subset of the first plurality of content items is removed from the display and a second subset of the first plurality of content items is added to the display; and displaying a second plurality of content items, over a second period of time, in response to an apparatus being positioned in a second position; wherein during the second period of time a first subset of the second plurality of content items is removed from the display and a second subset of the second plurality of content items is added to the display.

### FIELD OF THE INVENTION

Embodiments of the present invention relate to an apparatus, method, computer program and user interface. In particular, they relate to an apparatus, method, computer program and user interface for enabling content items to be provided to a user.

### BACKGROUND TO THE INVENTION

Apparatus which enables a plurality of content items to be provided to a user are known. For example a user may use a hand held electronic device, such as a mobile telephone, to access a large amount of content. For example, the device may be used to access websites or to render content such as audio or visual content which is stored in the device itself. It is useful to enable a user to easily find and access content.

### BRIEF DESCRIPTION OF VARIOUS EMBODIMENTS OF THE INVENTION

According to various, but not necessarily all, embodiments of the invention there is provided a method comprising: displaying, on a display of an apparatus, a first plurality of content items, over a first period of time, in response to the apparatus being positioned in a first position; wherein during the first period of time a first subset of the first plurality of content items is removed from the display and a second subset of the first plurality of content items is added to the display; and displaying a second plurality of content items, over a second period of time, in response to an apparatus being positioned in a second position; wherein during the second period of time a first subset of the second plurality of content items is removed from the display and a second subset of the second plurality of content items is added to the display.

In some embodiments of the invention the position of the apparatus may comprise the orientation of the apparatus. The position of the apparatus may also comprise the location of the apparatus.

In some embodiments of the invention the second plurality of content items may replace the first plurality of content items when the apparatus is moved from the first position to the second position.

In some embodiments of the invention the apparatus may be configured in a locked state wherein when the apparatus is configured in the locked state the apparatus may be moved from the first position without replacing the first plurality of content items.

In some embodiments of the invention the method may also comprise storing a subset of the plurality of items which are not currently displayed on the display in a queue. The content items may be added to the display in the order in which they are stored in the queue. The order of the content items in the queue may be determined by a user of the apparatus.

In some embodiments of the invention the method may also comprise displaying an image wherein a first image is displayed when the apparatus is a first position and a second image is displayed when the apparatus is in the second position. The image may comprise a map. The content items may be associated with the area indicated by the map.

In some embodiments of the invention the types of content items displayed may be selected by a user.

In some embodiments of the invention the number of content items displayed simultaneously may be determined by a user.

According to various, but not necessarily all, embodiments of the invention there is also provided an apparatus comprising: a display; at least one processor: and at least one memory including computer program code; wherein the at least one memory and the computer program code are configured to, with the at least one processor, enable the apparatus to; display a first plurality of content items, over a first period of time, in response to the apparatus being positioned in a first position; wherein during the first period of time a first subset of the first plurality of content items is removed from the display and a second subset of the first plurality of content items is added to the display; and display a second plurality of content items, over a second period of time, in response to the apparatus being positioned in a second position; wherein during the second period of time a first subset of the second plurality of content items is removed from the display and a second subset of the second plurality of content items is added to the display.

In some embodiments of the invention the position of the apparatus may comprise the orientation of the apparatus. The position of the apparatus may also comprise the location of the apparatus.

In some embodiments of the invention the at least one memory and the computer program code may be further configured to, with the at least one processor, enable the apparatus to replace the first plurality of content items with the second plurality of content items when the apparatus is moved from the first position to the second position.

In some embodiments of the invention the at least one memory and the computer program code may be further configured to, with the at least one processor, enable the apparatus to configure the apparatus in a locked state wherein when the apparatus is configured in the locked state the apparatus may be moved from the first position without replacing the first plurality of content items.

In some embodiments of the invention the at least one memory and the computer program code may be further configured to, with the at least one processor, enable the apparatus to store a subset of the plurality of items which are not currently displayed on the display in a queue.

In some embodiments of the invention the content items may be added to the display in the order in which they are stored in the queue. The order of the content items in the queue may be determined by a user of the apparatus.

In some embodiments of the invention the apparatus may be configured to display an image wherein a first image is displayed when the apparatus is a first position and a second image is displayed when the apparatus is in the second position. The image may comprise a map. The content items may be associated with the area indicated by the map.

In some embodiments of the invention the types of content items displayed may be selected by a user.

In some embodiments of the invention the number of content items displayed simultaneously may be determined by a user.

According to various, but not necessarily all, embodiments of the invention there is also provided a computer program comprising computer program instructions that, when executed by at least one processor, enable an apparatus at least to perform: displaying, on a display, a first plurality of content items, over a first period of time, in response to the apparatus being positioned in a first position; wherein during the first period of time a first subset of the first plurality of content items is removed from the display and a second subset of the first plurality of content items is added to the display; and displaying a second plurality of content items, over a second period of time, in response to the apparatus being positioned in a second position; wherein during the second period of time a first subset of the second plurality of content items is removed from the display and a second subset of the second plurality of content items is added to the display.

In some embodiments of the invention there may also be provided a computer program comprising program instructions for causing a computer to perform the method as described above.

In some embodiments of the invention there may also be provided a physical entity embodying the computer program as described above.

In some embodiments of the invention there may also be provided an electromagnetic carrier signal carrying the computer program as described above.

According to various, but not necessarily all, embodiments of the invention there is also provided a user interface comprising: a display configured to display a first plurality of content items, over a first period of time, in response to an apparatus being positioned in a first position; wherein during the first period of time a first subset of the first plurality of content items is removed from the display and a second subset of the first plurality of content items is added to the display; and display a second plurality of content items, over a second period of time, in response to the apparatus being positioned in a second position; wherein during the second period of time a first subset of the second plurality of content items is removed from the display and a second subset of the second plurality of content items is added to the display.

In some embodiments of the invention the position of the apparatus may comprise the orientation of the apparatus. The position of the apparatus may also comprise the location of the apparatus.

The apparatus may be for wireless communication.

### BRIEF DESCRIPTION OF THE DRAWINGS

For a better understanding of various examples of embodiments of the present invention reference will now be made by way of example only to the accompanying drawings in which:

FIG. 1 schematically illustrates an apparatus according to an exemplary embodiment of the invention;

FIG. 2 schematically illustrates an apparatus according to another exemplary embodiment of the invention;

FIG. 3 is a block diagram which schematically illustrates a method according to an exemplary embodiment of the invention

FIG. 4 schematically illustrates an exemplary embodiment of the invention in more detail

FIG. 5 illustrates a graphical user interface according to an exemplary embodiment of the invention; and

FIG. 6 illustrates a graphical user interface according to another exemplary embodiment of the invention.

### DETAILED DESCRIPTION OF VARIOUS EMBODIMENTS OF THE INVENTION

The Figures illustrate a method comprising: displaying, on a display 15 of an apparatus 1, a first plurality of content items, over a first period of time, in response to the apparatus 1 being positioned in a first position; wherein during the first period of time a first subset of the first plurality of content items is removed from the display 15 and a second subset of the first plurality of content items is added to the display 15; and displaying a second plurality of content items, over a second period of time, in response to an apparatus 1 being positioned in a second position; wherein during the second period of time a first subset of the second plurality of content items is removed from the display 15 and a second subset of the second plurality of content items is added to the display 15.

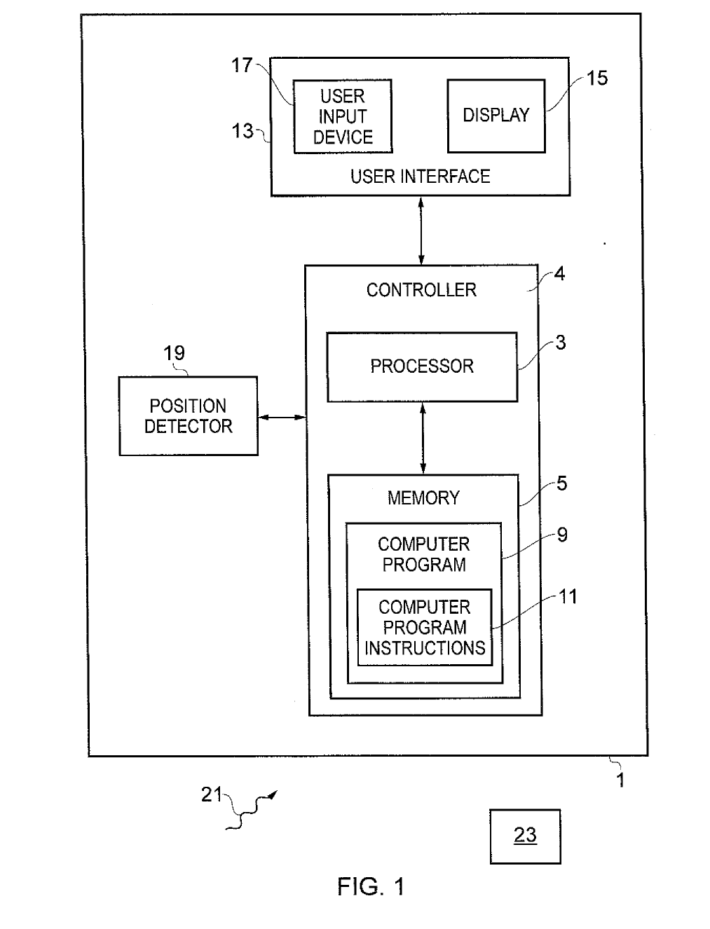

FIG. 1 schematically illustrates an apparatus 1 according to an embodiment of the invention. The apparatus 1 may be an electronic apparatus. The apparatus 1 may be, for example, a mobile cellular telephone, a personal computer, a camera, a gaming device, a personal digital assistant, a personal music player or any other apparatus which enables a user to make user inputs to control the apparatus 1. The apparatus 1 may be a handheld apparatus 1 which can be carried in a user's hand, handbag or jacket pocket for example.

Only features referred to in the following description are illustrated in FIG. 1. However, it should be understood that the apparatus 1 may comprise additional features that are not illustrated. For example, in embodiments of the invention where the apparatus 1 is a mobile cellular telephone, the apparatus 1 may also comprise a transmitter and receiver configured to enable wireless communication.

The apparatus 1 illustrated in FIG. 1 comprises: a user interface 13, a position detector 19 and a controller 4. In the illustrated embodiment the controller 4 comprises at least one processor 3 and at least one memory 5 and the user interface 13 comprises a display 15 and a user input device 17.

The controller 4 provides means for controlling the apparatus 1. The controller 4 may be implemented using instructions that enable hardware functionality, for example, by using executable computer program instructions 11 in one or more general-purpose or special-purpose processors 3 that may be stored on a computer readable storage medium 23 (e.g. disk, memory etc) to be executed by such processors 3.

The controller 4 may be configured to control the apparatus 1 to perform a plurality of different functions. For example, where the apparatus 1 is a mobile cellular telephone the controller 4 may be configured to control the apparatus 1 to make and receive telephone calls and also to perform other functions such as send messages or access communication networks such as local area networks or the internet.

The controller 4 may also be configured to enable the apparatus 1 to display, on the display 15, a first plurality of content items, over a first period of time, in response to the apparatus 1 being positioned in a first position; wherein during the first period of time a first subset of the first plurality of content items is removed from the display 15 and a second subset of the first plurality of content items is added to the display 15; and displaying a second plurality of content items, over a second period of time, in response to an apparatus 1 being positioned in a second position; wherein during the second period of time a first subset of the second plurality of content items is removed from the display 15 and a second subset of the second plurality of content items is added to the display 15.

The at least one processor 3 is configured to receive input commands from the user interface 13 and also to provide output commands to the user interface 13. The at least one processor 3 is also configured to write to and read from the at least one memory 5. Outputs of the user interface 13 are provided as inputs to the controller 4.

The user input device 17 provides means for enabling a user of the apparatus 1 to input information which may be used to control the apparatus 1. The user input device 17 may also enable a user to input information which may be stored in the one or more memories 5 of the apparatus 1. The user input device 17 may comprise any means which enables a user to input information into the apparatus 1. For example the user input device 17 may comprise a keypad or a portion of a touch sensitive display or a combination of a number of different types of user input devices.

The display 15 may comprise any means which enables information to be displayed to a user of the apparatus 1. The information may correspond to information which has been input by the user via the user input device 17, information which is stored in the one or more memories 5 or information which has been received by apparatus 1.

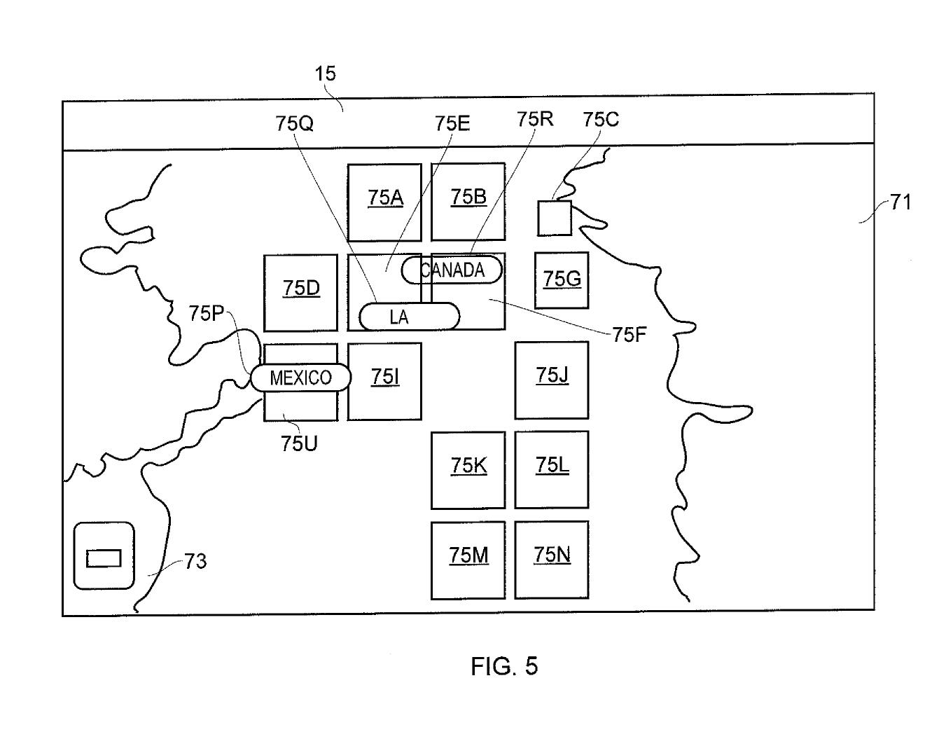

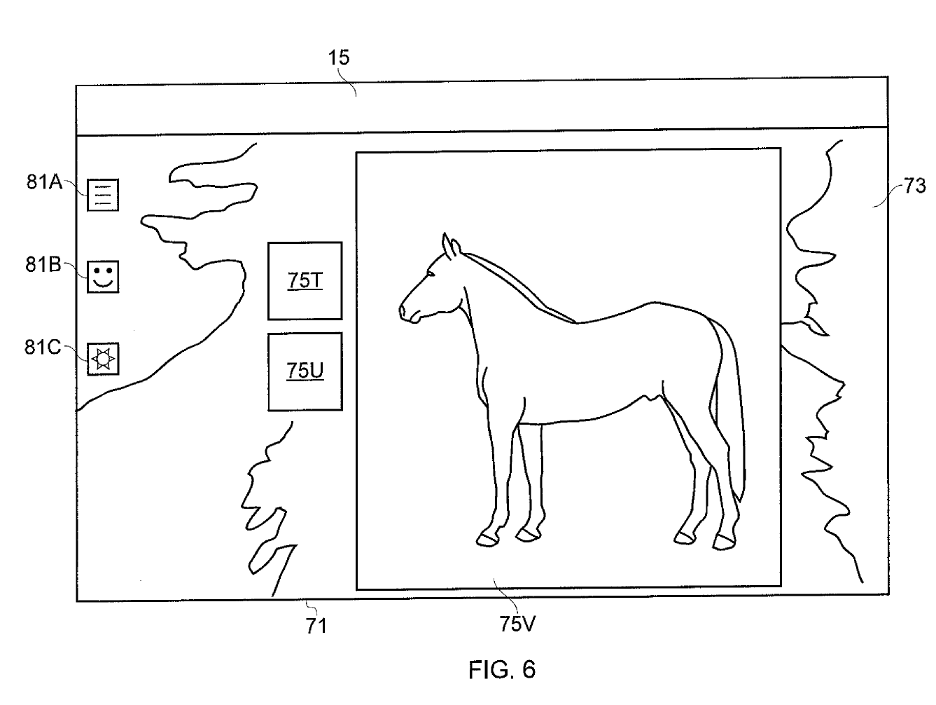

The display 15 may be configured to display graphical user interfaces 71 as illustrated in FIGS. 5 and 6.

The apparatus 1 comprises a position detector 19. The position detector 19 may comprise any means which enables a first position of the apparatus 1 to be distinguished from a second position of the apparatus 1. For example, the position detector 19 may comprise means for detecting the orientation of the apparatus 1. The position detector 19 may be configured to determine the angle or pitch of the apparatus relative to a plane of reference such as the ground. In such embodiments of the invention the position detector 19 may comprise an accelerometer, a gyroscope or any other suitable detection means.

In some embodiments of the invention the position detector 19 may also comprise means for detecting the location of the apparatus 1. The location of the apparatus 1 may be the geographic location. For example, the city or country in which the apparatus 1 is located. In such embodiments of the invention the position detector 19 may comprise a global positioning module or any other suitable means.

The position detector 19 is configured to receive control inputs from the controller 4. The position detector 19 is also configured to provide an output to the controller 4 where the output is indicative of the position of the apparatus 1.

In some embodiments of the invention the position of the apparatus 1 may be determined without using a position detector 19. For example a user may be able to input the location of the apparatus 1 by inputting position information such as geographical coordinates or a zip code.

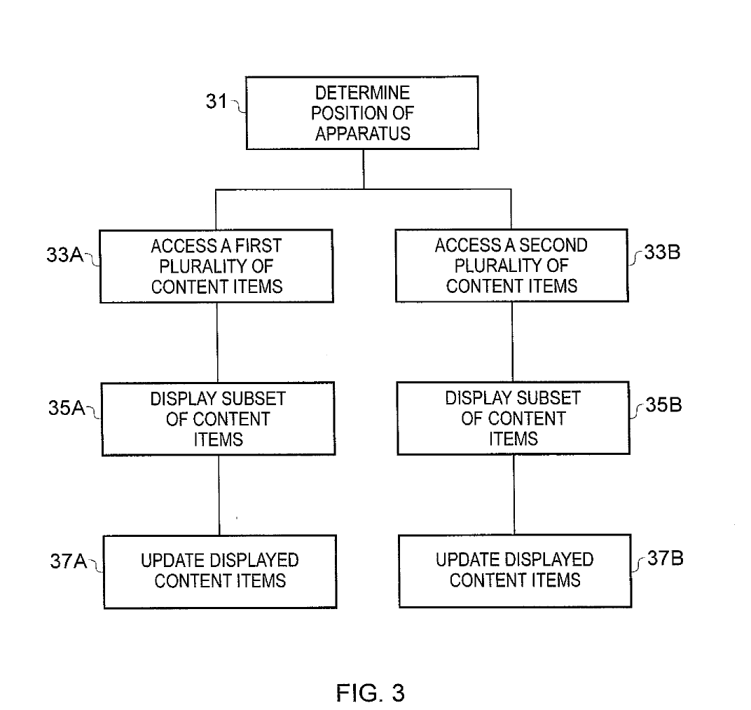

The at least one memory 5 stores a computer program code 9 comprising computer program instructions 11 that control the operation of the apparatus 1 when loaded into the at least one processor 3. The computer program instructions 11 provide the logic and routines that enable the apparatus 1 to perform the methods illustrated in FIG. 3. The at least one processor 3 by reading the at least one memory 5 is able to load and execute the computer program 9.

The computer program instructions 11 may provide computer readable program means configured to control the apparatus 1. The program instructions 11 may provide, when loaded into the controller 4; means for displaying, on a display 15 of an apparatus 1, a first plurality of content items, over a first period of time, in response to the apparatus 1 being positioned in a first position; wherein during the first period of time a first subset of the first plurality of content items is removed from the display 15 and a second subset of the first plurality of content items is added to the display 15; and means for displaying a second plurality of content items, over a second period of time, in response to an apparatus 1 being positioned in a second position; wherein during the second period of time a first subset of the second plurality of content items is removed from the display 15 and a second subset of the second plurality of content items is added to the display 15.

The computer program code 9 may arrive at the apparatus 1 via any suitable delivery mechanism 21. The delivery mechanism 21 may be, for example, a computer-readable storage medium, a computer program product 23, a memory device, a record medium such as a CD-ROM or DVD, an article of manufacture that tangibly embodies the computer program code 9. The delivery mechanism may be a signal configured to reliably transfer the computer program code 9. The apparatus 1 may propagate or transmit the computer program code 9 as a computer data signal.

Although the memory 5 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (e.g. Von Neumann)/parallel architectures but also specialized circuits such as field-programmable gate arrays (FPGA), application integration specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

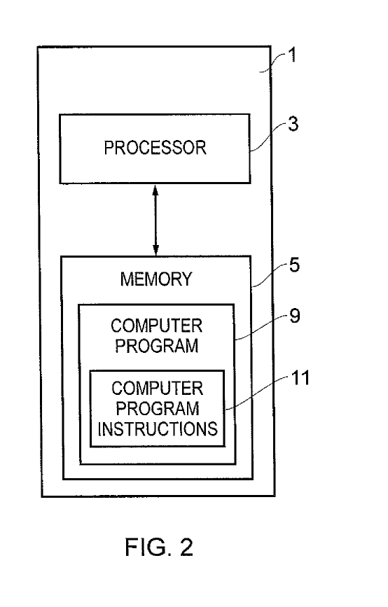

FIG. 2 illustrates an apparatus 1′ according to another embodiment of the invention. The apparatus 1′ illustrated in FIG. 2 may be a chip or a chip-set. The apparatus 1′ comprises at least one processor 3 and at least one memory 5 as described above in relation to FIG. 1.

A method of controlling the apparatus 1, according to embodiments of the invention, is illustrated schematically in FIG. 3.

At block 31 the position detector 19 determines the position of the apparatus 1. As mentioned above the position of the apparatus 1 may be the orientation of the apparatus 1, for example, whether the apparatus 1 is pointed towards the ground or not or the pitch or angle of the apparatus 1 relative to a plane of reference. In some embodiments of the invention the position detector 19 may determine the direction in which the apparatus 1 is oriented, for example, whether the apparatus 1 is pointed North, South, East or West.

The position detector 19 may also determine the location of the apparatus 1.

The position detector 19 may determine the city or country that the apparatus 1 is located in. In some embodiments of the invention the position detector 19 may be precise enough to determine the geographic coordinates of the apparatus 1.

As mentioned above, in some embodiments of the invention, a user of the apparatus 1 may input the position of the apparatus 1 manually rather than use a position detector 19. For example, the user may use the user input device 17 to input information indicative of the location of the apparatus 1.

If the apparatus 1 is positioned at a first location then at block 33A a first plurality of content items is accessed.

In some embodiments of the invention the first plurality of content items may be stored in the at least one memory 5 of the apparatus 1. In such embodiments of the invention the first plurality of content items may be accessed by accessing the at least one memory 5 and retrieving the content items. In other embodiments of the invention the first plurality of content items may be stored externally of the apparatus 1. In these embodiments of the invention the first plurality of content items may be accessed by accessing an external entity such as a server 55 and retrieving the content items from the external entity. It is to be appreciated that in some embodiments of the invention the first plurality of content items may comprise both items which are stored in the at least one memory 5 of the apparatus 1 and also items which are stored externally of the apparatus 1.

The first plurality of content items may comprise different types of content items. The content items may comprise text. The text may provide a label or further information relating to an image displayed on the display 15. The content item may comprise a user selectable icon. The user selectable icon may be selected by a user to enable content to be rendered. The user selectable icon may comprise an image, such as a thumbnail image, indicative of the content associated with the icon. Alternatively or in addition, the content item may also comprise a link or a shortcut which enables a user to access content such as a web site.

At block 35A a first subset of the first plurality of content items is displayed on the display 15.

The first subset of the first plurality of content items may be displayed overlaying a background image. The background image may be determined by the position of the apparatus 1. That is, a first background image may be displayed in response to the apparatus 1 being positioned in a first position and a second, different background image may be displayed in response to the apparatus 1 being positioned in a second position.

In some embodiments of the invention the background image may comprise a map 73. The map 73 may be indicative of the area in which the apparatus 1 is located. In other embodiments of the invention the map 73 may be indicative of an area which is not where the apparatus 1 is located. For example, by pointing the device in a downward direction a map corresponding to the area on the opposite side of the world may be displayed on the display 15. The user may be able to change the area of the map which is displayed by moving the apparatus 1 either by changing the orientation of the apparatus 1 and/or moving the location of the apparatus 1. In some embodiments of the invention the user may also be able to change the area of the map which is displayed by making a specific type of user input. For example a user may be able to make user inputs to pan across the map. The user may also be able to change the area of the map which is displayed by zooming in and out of the map so that the scale of the map on the display 15 changes.

The content items which are accessed may be associated with the background image. The content items may comprise further information relating to the image. For example, where the background image is a map, the content items may comprise labels, indicating points on the map, images which show areas on the map in more detail or links which enable a user to access further information about the area. The content items which are accessed may change whenever the background image is changed. For example, where the background image comprises a map 73, the content which is accessed may be updated whenever the area of the map displayed on the display 15 changes. This may be in response to movement of the apparatus 1 or a specific user input.

Only a first subset of the first plurality of content items is displayed simultaneously. A second subset of the first plurality of content items is not displayed on the display 15. The non-displayed subset of the first plurality of content items may be stored in the at least one memory 5 of the apparatus 1. The non-displayed subset of the first plurality of content items may be stored in a queue. The content items may be ordered within the queue according to specific criteria. The specific criteria may be selected by a user. For example, a user may indicate the type of content or information they are most interested in and the items may be stored in the queue in order of user preference. The user may indicate their preferred type of content by making a specific selection, for example, selecting an item from a menu. In other embodiments of the invention the use history of the apparatus 1 may be used to determine a user's preferred type of content items. In other embodiments of the invention the criteria could be for example, a perceived importance of the content item, for example the significance of a news item or the popularity of content item, for example, the number of times the content item has been accessed.

The number of content items which are displayed simultaneously may be determined by the user of the apparatus 1. For example, a user may be able to access a menu and select an option which enables a user to select the types of content items which are displayed simultaneously and the number of each type of content item which is displayed simultaneously. In some embodiments of the invention the user may also be able to select the amount of time a content item is displayed on the display 15 before it is removed and a new content item is added.

At block 37A the displayed content items are updated. The displayed content items may be updated after a predetermined period of time has elapsed. As mentioned above, the user of the apparatus 1 may be able to select the length of the predetermined period of time.

The displayed content items may be updated by removing one or more of the displayed content items from the display 15 and adding one of more of the non-displayed content items from the queue to the display 15. In some embodiments of the invention the number of content items displayed on the display 15 at any given time may be constant so that for each content item that is removed from the display 15 a new content item is added.

The content items may be added to the display 15 in the order in which they are stored in the queue. When a displayed content item is removed from the display 15 it may be stored at the back of the queue. Blocks 35A and 37A may be repeated any number of times so that all of the first plurality of content items may be displayed over a long enough period of time.

If, at block 31, the position detector 19, determines that the apparatus 1 is in a second position then at block 33B a second plurality of content items are accessed, at block 35B a subset of the second plurality of content items is displayed and at block 37B the displayed content items are updated by removing one or more of the displayed content items and adding one or more new content items from the second plurality of content items.

It is to be appreciated that the method associated with blocks 33B to 37B may be identical to the blocks 33A to 37A except that a different plurality of content items is used because the apparatus 1 has been determined to be in a different position.

In FIG. 3 only a first position and a second position are indicated. It is to be appreciated that any number of different positions may be available. For example, the position detector 19 may be configured to distinguish between any number of different positions. Each different position may enable access to a different plurality of content items. This may enable a user to access any number of different pluralities of content items simply by moving their apparatus 1.

The blocks illustrated in FIG. 3 may represent steps in a method and/or sections of code in the computer program 9. The illustration of a particular order to the blocks does not necessarily imply that there is a required or preferred order for the blocks and the order and arrangement of the blocks may be varied. Furthermore, it may be possible for some blocks to be omitted.

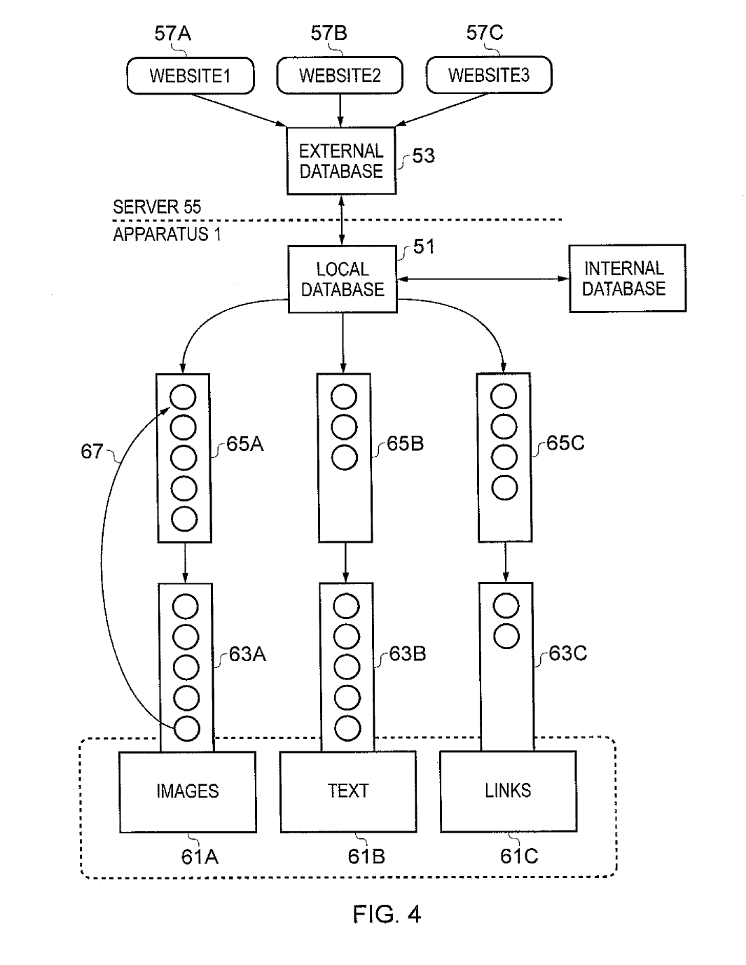

FIG. 4 schematically illustrates a system for accessing, displaying and storing content items according to an exemplary embodiment of the invention.

In the embodiment illustrated in FIG. 4 the accessed content items may be stored in a local database 51. The local database 51 may be stored in the one or more memories 5 of the apparatus 1 which may be accessed by the controller 4.

The accessed content items may be retrieved from an external database 53. The external database 53 may be stored in a remote device such as a server 55. The content items may be provided to the local database 51 from the external database 53 via any suitable communication link. The external database 53 may obtain the content items from a plurality of different sources. In the illustrated embodiments the plurality of different sources comprises a plurality of different websites 57A, 57B, 57C.

It is to be appreciated that in other embodiments of the invention the local database 51 may obtain the content items directly from the sources such as the websites 57A, 57B, 57C. In such embodiments of the invention any processing required on the content items may be carried out within the apparatus 1.

In some embodiments of the invention some of the accessed content items may be retrieved from an internal database 59. The internal database 59 may be stored in the at least one memory 5 of the apparatus 1 and may contain, for example, contact information, calendar information or content such as audio files or images which have been downloaded by the user. The content items stored in the internal database 59 may be used by the controller 4 when enabling other functions of the apparatus 1 to be performed. For example the contact information may be used when enabling the communications functions of the apparatus 1.

In the system illustrated schematically in FIG. 4 the accessed content items comprise three different types of content items. The first type of content items 61A comprises images, the second type of content items 61B comprises text and the third type of content items 61C comprises links to external websites. It is to be appreciated that other types of content may be provided in other embodiments of the invention.

Each of the different types of content items are separated into a displayed subset 63A, 63B, 63C and a non-displayed subset 65A, 65B, 65C. The displayed subset 63A, 63B, 63C comprises the items which are currently displayed on the display 15. The non-displayed subset 65A, 65B, 65C comprises the items which have been accessed but which are not currently displayed on the display 15. As described above, the non-displayed subset 65A, 65B, 65C of content items is stored in a queue. The items may be ordered in the queue according to specific criteria such as perceived importance or popularity of the item.

The number of content items in the displayed subset 63A, 63B, 63C may be controlled by a user. That is, a user may be able to control the amount of information which is displayed on the display 15 simultaneously. The number of content items in the displayed subset 63A, 63B, 63C may be different for each of the different types of content items.

The number of content items in the non-displayed subset 65A, 65B, 65C may be determined by the number of content items which have been accessed and which are stored in the local database 51. In some embodiments of the invention, any content item which has been accessed but which is not currently displayed may be stored in the non-displayed subset.

After a predetermined amount of time has elapsed the displayed subset 63A, of content items is updated, as indicated by arrow 67 by removing one of the content items from the displayed subset 63A and moving it to the back of the queue in the non-displayed subset 65A. A new content item is also added to the displayed subset 63A. The new content item may be added from the front of the queue of the non-displayed subset 65A. It is to be appreciated that the other displayed subsets of content items 63B, 63C may also be updated in the same manner.

The content items which are stored in the local database 51 may also be updated. For example, the accessed content items may be updated whenever the apparatus 1 is determined to have changed position. The content items may also be updated over time, for example, some of the content items may expire after a given time period and some new content items may become available. The update of the content items which are stored in the local database 51 may change the content items in the displayed subsets 63A, 63B, 63C thereby changing the content items which are displayed on the display 15.

FIG. 5 illustrates a graphical user interface 71 according to an exemplary embodiment of the invention. The graphical user interface 71 may be displayed on the display 15.

The graphical user interface 71 comprises a map 73. In the illustrated embodiment the map 73 is displayed in the background and a plurality of content items 75A-R are displayed overlaying the map 73. The content items 75A-R may be associated with the area indicated by the map 73.

In the particular embodiment illustrated in FIG. 5 the map 73 is indicative of an area on the opposite side of the world to the apparatus 1. The map 73 is displayed as though the user could see through the earth, that is the map 73 is displayed in reverse to a map which would typically be displayed on a map of the globe. In some embodiments of the invention different sections of the map 73 may be displayed in different colors. This may provide an indication of the relative times of day in the areas displayed on the map 73. That is, it enables a user to see whether it is day time or night time in the respective areas of the map.

As mentioned above a plurality of different content items 75A-R are displayed in the graphical user interface overlaying the map. In this particular embodiment some of the content items 75A-N comprise user selectable icons which enable a user to access content. In some embodiments of the inventions the user selectable icons comprise an image indicative of the content associated with the icon. In some embodiments of the invention the image may comprise an animated image. In the particular embodiment illustrated in FIG. 5 the content items 75A-N are arranged in a regular array. The array comprises a grid with a predetermined number of rows and a predetermined number of columns. The number of rows and columns may depend upon the size of the display and the size of the content items 75A-N. The content items 75A-N may be displayed at any position within the grid. The number of content items 75A-N displayed may be less than the number of spaces available in the grid. This provides an organized array in which a user can clearly see and select the different content items 75A-N. Also as there are places in the grid in which no content item 75A-N is displayed, this enables the background image to be viewed through the array.

Some of the content items 75P-R may comprise a label. In the embodiment illustrated in FIG. 5 the labels are indicative of the areas displayed on the map 73. A user may be able to select whether or not the labels are displayed, the number of labels which are displayed and the type of information which is provided in the labels. For example a user may select whether the labels comprise text and/or images. The user may also be able to select the information in the labels, for example, whether areas on a map are labeled or the name of a contact or some local information such as weather information is provided.

A zoom icon 77 is also provided. The user may select the zoom icon 77 to change the scale of the map 73 on the display 15. As mentioned above, changing the scale of the map 73 on the display 15 may also change the content items which are accessed.

In the embodiment illustrated in FIG. 5. One of the content items 75C is being removed from the display 15 and a new content item 75G is being added to the display 15. In this particular embodiment the content item 75C which is being removed from the display 15 decreases in size until it is no longer displayed on the display 15 while the content item 75G which is being added to the display 15 may increase in size until it is the same size as the other content items on the display. In this particular embodiment the new content item 75G is displayed in a different area of the display 15 to the content item 75C which has been removed.

FIG. 6 illustrates another graphical user interface 71 according to another exemplary embodiment of the invention. As in the previous embodiment the graphical user interface 71 may be displayed on the display 15.

The graphical user interface 71 in FIG. 6 also comprises a map 73 which is displayed in the background. The map 73 may be provided in the same manner as the map lustrated in FIG. 5.

In FIG. 6 a plurality of content items 75T-V are displayed overlaying the map 73. The content items 75T-V may be associated with the area indicated by the map 73.

In FIG. 6 a user has selected on of the displayed content items 75T-V. The content items 75T, 75U which have not been selected the content are displayed in the same manner as the content items displayed in FIG. 5. However the third content item 75V, which has been selected, is now displayed larger than the other content items 75T, 75U to enable a preview of the content associated with the content item 75V to be provided to the user. The enlarged content item 75V may overlay other content items, for example there may be other content items which were previously visible on the display before the content item 75V was selected but which have now been obscured by the enlarged content item 75V.

In the particular embodiment illustrated in FIG. 6 the preview comprises an image. The image may be a still image such as a photograph or an animated image such as a video. In some embodiments of the invention some audio or text content may also be provided in the preview. The user may use the preview to determine whether or not they would like to select the content so that the content maybe rendered.

The graphical user interface 71 illustrated in FIG. 6 also comprises a plurality of user selectable icons 81A, 81B, 81C. The plurality of user selectable icons 81A, 81B, 81C may enable a user to easily select the different types of content items which they would like to be displayed. For example selection of the first icon 81A may enable the user to select the number and type of labels which are provided. The second icon may enable the user to select the number of content items associated with contact information which are provided and the third icon may enable a user to select the number of content items associated with the weather. This may enable a user to easily access all the content items of a particular type. The plurality of user selectable icons 81A, 81B, 81C may also enable a user to change the type of content which is provided in the preview.

In some embodiments of the invention the graphical user interface 71 may provide a visual link between a specific area of the map and a content item associated with that area. For example, when the content item 75 is being added to the display 15 it may be animated to appear as though the content item 75 is coming from the area of the map 73 associated with the content item. This may make it easier for a user to associate the content with the areas on the map 73.

Embodiments of the invention enable a large amount of content to be provided to a user in a manner which is simple and intuitive for the user. By rotating the content items using a queuing system, over a period of time, a large amount of information can be provided to a user without overwhelming the user. Also the user may be able to control the amount of content items which are provided simultaneously. This enables the user to control the apparatus 1 to provide the content at a volume and rate which the user prefers.

Providing different content items when the apparatus 1 is positioned in different positions enables a user to easily access different content items simply by moving their apparatus 1 or changing the orientation of their apparatus 1. The user may be able to associate particular positions of their apparatus 1 with particular content items. The user may learn, for example, that when they are sitting at their desk pointing their apparatus 1 directly at the floor this will enable them to access content items relating to a particular geographical area.

Using the position of the apparatus to determine a map which is displayed on the displayed also enables a user to become more aware of their surroundings.

Although embodiments of the present invention have been described in the preceding paragraphs with reference to various examples, it should be appreciated that modifications to the examples given can be made without departing from the scope of the invention as claimed. For example in the above described embodiments a user can access different pluralities of content items by moving their apparatus 1. It may be useful to enable a user to move the apparatus 1 without changing the content items which are accessed. For example they might want to move the apparatus 1 to a more convenient position or show a content item to another person. In such embodiments of the invention the user may be able to access the content items by positioning the apparatus 1 in a first position. The user may then select a lock option which locks the position of the apparatus 1. When the position of the apparatus 1 has been locked the position detector 19 may be disabled so that it does not provide an output to the controller 4 indicating when the position of the apparatus 1 has changed. This may lock the content items which have been accessed so that the accessed content items are not changed even when the apparatus 1 is moved. The content items may still be rotated between the queue and the display, however, no new content items are accessed from a database.

The content items may be provided in any suitable manner. In some embodiments of the invention particular types of content may be indicated by a generic image. For example all contact information may be indicated by a dot on an area of a map. A user may determine the specific contact information associated with a specific dot by selecting the dot.

It is to be appreciated that the content associated with the content items may relate to any suitable subject matter. For example, in the above description the content items relate to the areas on a map of the earth. In some embodiments of the invention the content items may be associated with the sky

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1-33. (canceled)

34. A method comprising:
determining a position of an apparatus, the position comprising location and orientation where the orientation comprises an angle of the apparatus relative to a plane of reference;
causing, in response to the determining, information to be displayed wherein the information is dependent on the determined position of the apparatus and comprises information relating to a location which is on an opposite side of the world to the determined location of the apparatus.

35. A method as claimed in claim 34 wherein the plane of reference is horizontal.

36. A method as claimed in claim 34 wherein the plane of reference comprises the ground.

37. A method as claimed in claim 34 wherein the orientation comprises whether or not the apparatus is pointing towards the ground.

38. A method as claimed in claim 34 wherein the information is dependent on the determined position such that if the position is determined to be a first position first information is displayed and if the position is determined to be a second position second information is displayed.

39. A method as claimed in claim 34 wherein the information which is displayed comprises a background image and a plurality of content items associated with the background image.

40. A method as claimed in claim 39 wherein the background image comprises a map indicative of the location on the opposite side of the world.

41. An apparatus comprising:
at least one processor; and
at least one memory including computer program code;
wherein the at least one memory and the computer program code are configured to, with the at least one processor, enable the apparatus to;
determine a position of the apparatus, the position comprising location and orientation where the orientation comprises an angle of the apparatus relative to a plane of reference:
cause, in response to the determining, information to be displayed wherein the information is dependent on the determined position of the apparatus and comprises information relating to a location which is on an opposite side of the world to the determined location of the apparatus.

42. An apparatus as claimed in claim 41 wherein the plane of reference is horizontal.

43. An apparatus as claimed in claim 41 wherein the plane of reference comprises the ground.

44. An apparatus as claimed in claim 41 wherein the orientation comprises whether or not the apparatus is pointing towards the ground.

45. An apparatus as claimed in claim 41 wherein the information is dependent on the determined position such that if the position is determined to be a first position first information is displayed and if the position is determined to be a second position second information is displayed.

46. An apparatus as claimed in claim 41 wherein the information which is displayed comprises a background image and a plurality of content items associated with the background image.

47. An apparatus as claimed in claim 46 wherein the background image comprises a map indicative of the location on the opposite side of the world.

48. A computer program product embodied on a non-transitory computer-readable storage medium, the computer program product comprising program instructions operable to be loaded into a memory of a computer for causing the computer to perform the method of claim 34.
